(19) United States
(12) Patent Application Publication
(10) Pub. No.: US 2012/0261963 A1
(43) Pub. Date: Oct. 18, 2012

(54) Vehicle Seat with a Pivotably Connected Linking Member

(75) Inventor: Michael Henrich Joop Heyer, Haimhausen (DE)

(73) Assignee: LEAR CORPORATION, Southfield, MI (US)

(21) Appl. No.: 13/377,708

(22) PCT Filed: Jun. 10, 2009
(86) PCT No.: PCT/US09/46865

§ 371 Date: Jun. 28, 2012

(51) Int. Cl. B60N 2/02

(52) U.S. Cl. 297/313

(57) ABSTRACT

This invention relates in general to a vehicle seat having a mounting frame assembly connected to the vehicle floor, a seat bottom frame mounted for movement relative to the mounting frame assembly, and a link member connecting the mounting frame assembly and the seat bottom frame. The link member has a first connection to the seat bottom frame at one end of the link member and a second connection to the mounting frame assembly at another end of the link member, and one of the connections allows pivotal movement. The pivotal connection includes a protruding member extending through and retained in an aperture. The protruding member is a part of the mounting frame assembly, the seat bottom frame or the link member.

### BACKGROUND OF THE INVENTION

This invention relates in general to pivot joint assemblies, such as for example, those used in vehicle seat frames.

### SUMMARY OF THE INVENTION

This invention relates in general to a vehicle seat having a mounting frame assembly connected to the vehicle floor, a seat bottom frame mounted for movement relative to the mounting frame assembly, and a link member connecting the mounting frame assembly and the seat bottom frame. The link member has a first connection to the seat bottom frame at one end of the link member and a second connection to the mounting frame assembly at another end of the link member, and one of the connections allows pivotal movement. The pivotal connection includes a protruding member extending through and retained in an aperture. The protruding member is a part of the mounting frame assembly, the seat bottom frame or the link member.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a vehicle seat.

FIG. 2 is an enlarged perspective view of a frame assembly of the seat frame of FIG. 1 illustrating a pivot joint assembly.

FIG. 3 is an elevational side view of a portion of the seat frame of FIG. 1.

FIG. 4 is an elevational side view similar to FIG. 3 showing the seat bottom frame moved to a raised position.

FIG. 5 is an elevational side view of a front link member.

FIG. 6 is an elevational side view of the front link member of FIG. 5, after attachment to the vehicle seat frame.

FIG. 7 is an elevational side view of an alternative retaining means for the front link member.

FIG. 8 is a perspective view of a bushing prior to installation.

FIG. 9 is a cross-sectional view of the bushing of FIG. 8 being installed.

### DETAILED DESCRIPTION OF THE PREFERRED EMBODIMENT

Vehicle seats typically include a seat back frame mounted on a seat bottom frame. The seat back frame is pivotally mounted on the seat bottom frame for adjusting the seat back at a desired inclined angle relative to the seat bottom. The seat bottom frame is commonly mounted on the floor of the vehicle such that the position of the seat relative to the floor can be adjusted. Typically, the seat includes a mounting assembly attached between the floor and the seat bottom frame for adjusting the seat bottom in a fore and aft direction.

The mounting assembly may also be configured to adjust the vertical height of the seat bottom relative to the vehicle floor. To accomplish this, the mounting assembly may include an upper frame assembly connected to the seat bottom, and a lower frame assembly connected to the vehicle floor. The upper frame assembly is connected to the lower frame assembly by link members which are pivotally connected to the upper and lower frame assemblies. In some embodiments, the link members and the lower and upper frame assemblies form a four bar linkage. A lifting mechanism is connected between the upper and lower frame assemblies. A typical lifting mechanism is a linear electric power screw drive unit that includes a cylinder and an arm which is threadably engaged with the cylinder. Rotation of the cylinder or arm, such as by an electric motor, causes the arm to extend or retract relative to the cylinder. To move the seat bottom, the lifting mechanism is operated to pivot the upper frame assembly about the pivoting link members. The link members are oriented such that the upper frame assembly may be moved upwardly and downwardly upon rotation of the link members. Other mechanisms can be used to lifting the upper frame assembly.

Commonly, the upper frame assembly includes a pair of side brackets extending along the left and right-hand sides of the seat. The brackets are spaced from one another by cross members, such as a front bar and a rear bar. The bars are either solid or tubular. The bars are pivotally connected to the side brackets. Ends of the link members are connected to the bars. The other ends of the link members are pivotally connected to the lower frame assembly. As the upper frame assembly is moved by the lifting mechanism, the front and rear bars pivot relative to the upper frame assembly side brackets.

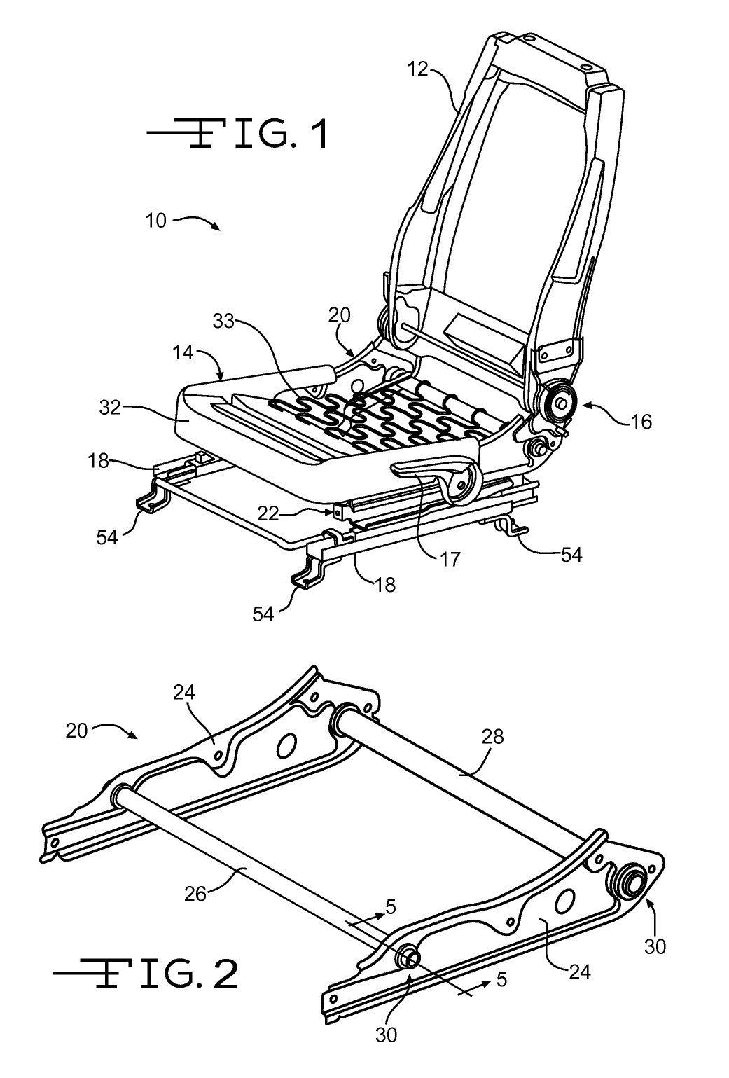

Referring now to the drawings, there is illustrated in FIG. 1 a vehicle seat frame, indicated generally at 10. The vehicle seat frame 10 includes a seat back frame 12 and a seat bottom frame, indicated generally at 14. To form a completed vehicle seat, the seat back frame 12 and seat bottom frame 14 are covered with padding and an outer trim cover layer (not shown).

The seat back frame 12 is usually pivotally mounted to the seat bottom frame 14 via a recliner mechanism, indicated schematically at 16, for adjusting the seat back frame 12 to a desired inclined angle relative to the seat bottom frame 14. The reclining feature is not necessary for operation of the vehicle seat. The recliner mechanism 16 may be operated manually by a handle 17 or may include a motor drive unit (not shown) for electric operation.

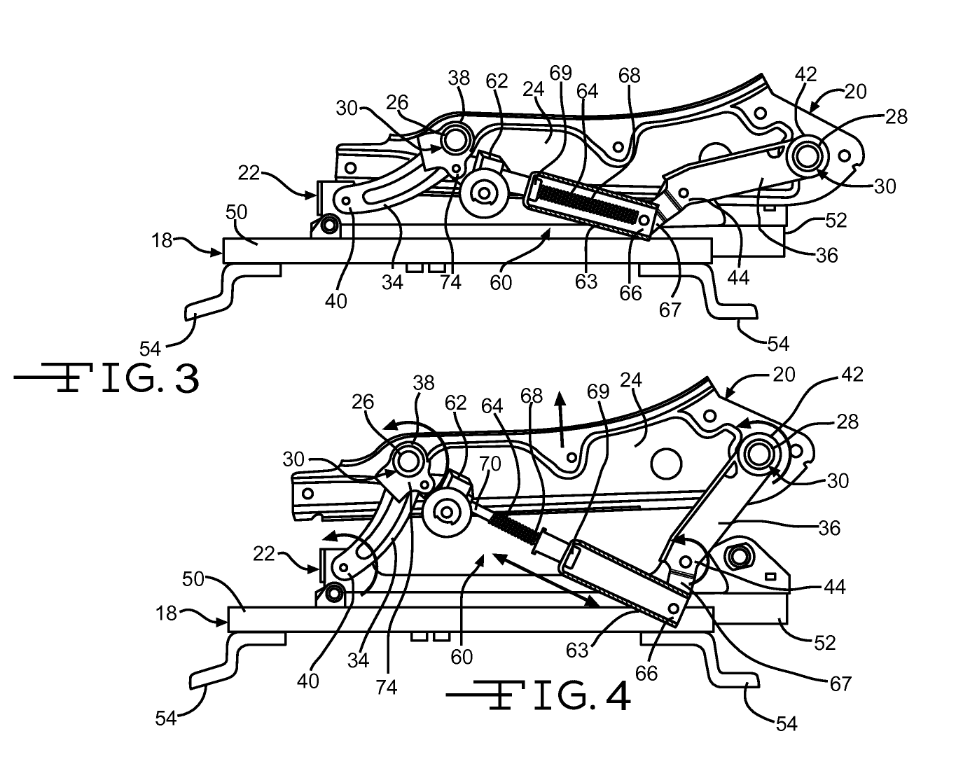

The vehicle seat frame 10 further includes a mounting frame assembly 18. As shown in FIGS. 3 and 4, the illustrated mounting frame assembly 18 includes a pair of lower tracks 50, a pair of upper tracks 52 and a first frame assembly 22. The lower tracks 50 are adapted to be fixed relative to the floor of the vehicle in which the vehicle seat frame 10 is installed via floor brackets 54. The upper tracks 52 are fixed relative to the lower frame assembly 22. The upper tracks 52 are slidably mounted on the respective lower tracks 54 to provide for a fore and aft adjustment of the vehicle seat frame 10 relative to the vehicle floor. A locking mechanism (not shown) is connected between the tracks 50 and 52 for releasably locking the upper tracks 52 relative to the lower tracks 50. Although one embodiment of a mounting frame assembly 18 is shown, it should be understood that mounting frame assemblies with different configurations can be used. For instance, the mounting frame assembly can be configured so that it does not include tracks 50 and 52, and does not provide for fore and aft adjustment of the vehicle seat frame. The illustrated mounting frame assembly 18 is connected to the vehicle floor via floor brackets 54. The connection can be a direct connection, or the mounting frame assembly can be connected to some other component of the vehicle or indirectly connected to the vehicle frame. The mounting frame could also be attached to allow some other type of movement relative to the vehicle, such as rotational movement of the mounting frame.

As best shown in FIGS. 2-4, the seat bottom frame 14 includes an upper frame assembly 20. As will be discussed below, the upper frame assembly 20 is movably mounted relative to the lower frame assembly 22 for adjusting the height or tilt of the seat bottom frame 14 relative to the floor of the vehicle. As shown in FIG. 2, the upper frame assembly 20 includes a pair of side brackets 24 which extends in a fore and aft direction along the lateral sides of the seat bottom frame 14. The side brackets 24 can be made of any suitable material, such as steel, and may be formed from a stamped piece.

The upper frame assembly 20 further includes a front bar 26 and a rear bar 28 extending between the side brackets 24. In the embodiment shown, each end of the bars 26 and 28 is connected to the side brackets 24 by a pivot joint, indicated generally at 30. The pivot joints 30 permit the bars 26 and 28 to rotate relative to the side brackets 26. In the illustrated embodiment, the bars 26 and 28 have a cylindrical tubular shape, and a hollow interior. The bars 26 and 28 can be made of any suitable material, such as steel. The seat bottom frame 14 may further include a seat pan 32 and a spring wire platform 33 attached to the upper frame assembly 20 for generally defining the front and central portions of the seat bottom frame 14.

As shown in FIGS. 1, 3 and 4, the mounting frame assembly 18 and the seat bottom frame 14 are connected together by a pair of front link members 34 and a pair of rear link members 36. In the illustrated embodiment, the front link members 34 and rear link members 36 are attached to the upper frame assembly 20 and the lower frame assembly 22. The front link members 34 are generally spaced from one another and are adjacent the side brackets 24. Similarly, the rear link members 36 are generally spaced from one another and are adjacent the side brackets 24.

The illustrated front link members 34 each include a first end 38 which is rigidly connected to the front bar 26. The front link members 34 each have a second end 40 which is pivotally attached to the lower frame assembly 22. Similarly, the rear link members 36 each include a first end 42 which is rigidly connected to the rear bar 28. The rear link members 36 each have a second end 44 which is pivotally attached to the lower frame assembly 22. The first ends 38 and 42 can be attached to the bars 26 and 28 by any suitable manner, such as by welding, adhesive, frictional fit or by fasteners. Alternatively, the first ends 38 and 42 may be pivotally attached to the bars 26 and 28.

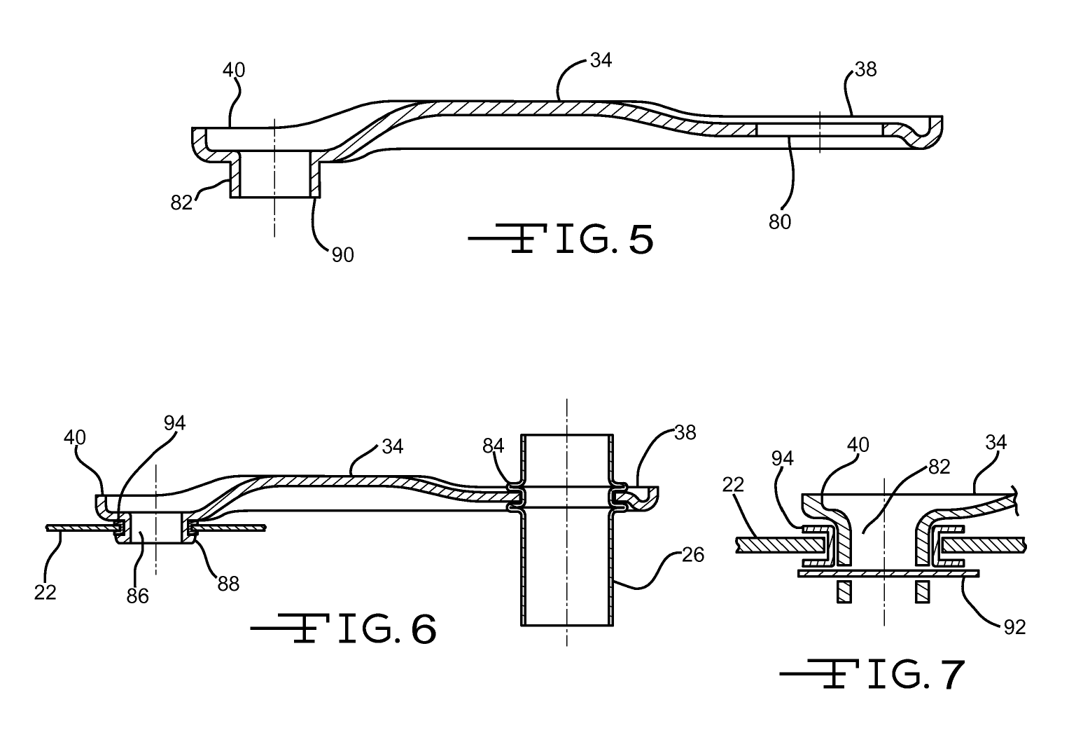

Referring to FIG. 5, there is shown a cross section view of one of the front link members 34. It should be understood that the illustrated rear link member 36 will have a similar cross section. In other embodiments, the front and rear link members can have different from each other. The link members can be made of any suitable material, such as steel. As previously described, the front link member 34 has a first end 38. In the illustrated embodiment, the first end 38 includes a hole 80. The hole 80 can have any suitable cross-sectional shape. The front link member 34 also has a second end 40. A protruding member 82 is included at the second end 40. In the illustrated embodiment, the protruding member 82 is integral with the front link member 34.

The protruding member 82 in the illustrated embodiment is created by plunging a hole in the second end 40 of the front link member 34. It should be understood that the protruding member 82 can be created by other methods, such as by a swaging operation, or by being molded or cast as part of the front link member 34. Additionally, it should be understood that the protruding member 82 need not be integral with the front link member. The protruding member 82 could be attached to the link member 34, for example by welding or with adhesives. Further, it should be appreciated that the protruding member may be part of the lower frame assembly 22. The illustrated protruding member 82 has a cylindrical cross-section, and is substantially perpendicular to the front link member 34. The shape and configuration of the protruding member 82 could be different from that illustrated.

Referring now to FIG. 6, the bar 26 extends through the hole 80 in order to provide a first connection 84 between the front link member 34 and the front bar 26. The illustrated first connection 84 is a rigid connection between the front link member 34 and the front bar 26. The protruding member 82 extends through a through hole 86 in the lower frame assembly 22 in order to provide a second connection 88 between the front link member 34 and the lower frame assembly 22. The illustrated second connection 86 is a pivotal connection between the front link member 34 and the lower frame assembly 22.

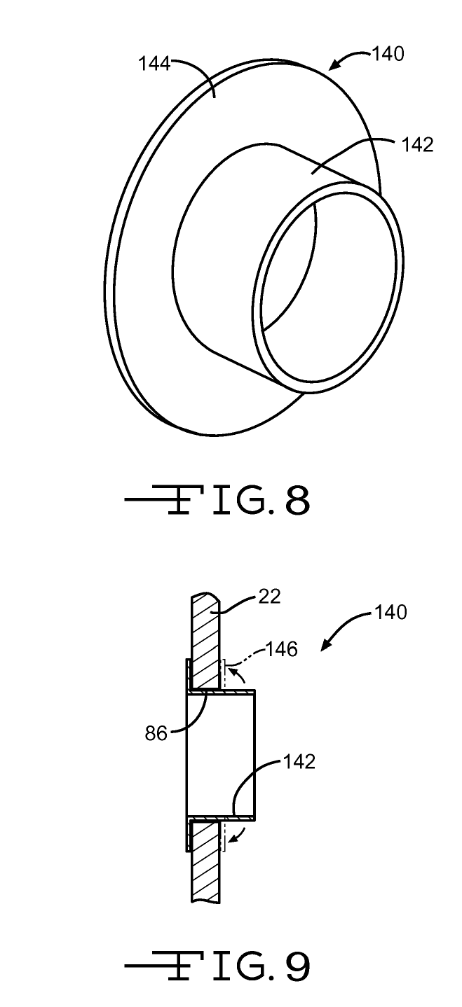

As illustrated, after the protruding member 82 is disposed within the through hole 86 in the lower frame assembly 22, the outer end 90 of the protruding member 82 is rolled over the lower frame assembly 22. This retains the protruding member 82 in the through hole 86. Any method may be used to roll over the protruding member 82, including magnetic pulse forming or orbital staking. Alternatively, the protruding member 82 may be retained in the through hole 86 by some other method, such as using a retaining pin 92, as shown in FIG. 7.

Although the protruding portion 82 has been described and shown as tubular in shape such that a portion of the tube is expanded radially outwardly and folded to retain the protruding portion 82 in the through hole 86, it should be understood that the protruding portion 82 may be solid, partially tubular in structure, or have some other shape.

In the illustrated embodiment, the pivot joint 30 includes an optional bushing 94. The bushing 94 reduces the contact between the lower frame member 22 and the front link member 34 and provides for a reduced frictional contact for the second connection 88. The bushing 94 also optionally reduces play and rattle noise in the second connection 88.

The bushing 94 can be any solid, liquid, or paste which helps to permit the pivoting motion of the front link member 34 relative to the lower frame assembly 22 after assembly of the second connection 88 as described above. Examples of a suitable bushing 94 includes non-solid lubricants, such as grease, or a coating formed on the adjacent surfaces of the side bracket adjacent the through hole 86. For example, the bushing 94 can be a reduced frictional coating or fluoropolymer such as polytetrafluoroethylene (PTFE), such as that commercially available from DuPont Company under the trade name Teflon. This coating may be coated around the edges adjacent the through hole 86. The cylindrical surface portion of the edge defined by the through hole 86 may or may not include bushing material.

Another example of a suitable bushing 94 is a solid grommet formed in the shape of the bushing 94 (illustrated in FIG. 6). Such a grommet is shown in FIGS. 8 and 9, and is indicated generally at 140. The grommet 140 is disposed within the through hole 86 of the lower frame assembly 22. In the illustrated embodiment, the grommet includes a tubular portion 142, an outwardly extending circular first flange 144, and an outwardly extending circular second flange, represented by broken lines 146 in FIG. 9 when formed. FIG. 8 illustrates the shape of the grommet 140 prior to final assembly of the second connection 88. FIG. 9 illustrates an assembly method of the grommet 140 on to the lower frame assembly 22. To assemble, the protruding member 82 is inserted though the through hole 86 until the first flange 144 abuts the lower frame assembly 22, as shown in FIG. 9. The second flange 146 is then formed by bending or forming the end of the protruding member 82 outwardly and against the lower frame assembly 22.

The grommet 140 may be made of any material, such as a polymer or polished metal, which has a relatively low coefficient of friction for permitting rotation of the protruding member 82 relative to the lower frame assembly 22 even when under a compressive load due to the formation of the second connection 88. In one embodiment, the coefficient of friction of the grommet 140 is lower than the coefficient of friction of the material of the protruding member 82 and the surface of the lower frame assembly 22. If desired, the grommet 140 may include a low coefficient of friction coating thereon.

In the illustrated embodiment, the protruding portion 82 is located on the second end 40 of the link member 34. It should also be understood that a protruding portion could be included on some other part of the link member 34, or that more than one protruding portion could be included on the link member 34. Also, a protruding portion could be located in some place other than the link member 34. For example, a protruding portion could be placed on lower frame assembly 22 and pass through a hole on the front link member 34. It should also be appreciated that the link member may be made of multiple pieces that are connected to each other.

In the illustrated embodiment the link member 34 includes two connections: A rigid first connection 84 and a pivotal second connection 86 created using the protruding portion 82. It should be understood that a protruding portion could be used to create a rigid connection as well as a pivotal connection. Further, the link member could have multiple rigid connections, as well as multiple pivotal connections.

In the illustrated vehicle seat assembly 10, the bars 26 and 28 are connected to the side brackets 24 by a pivot joint, indicated generally at 30. It should be understood that the bars 26 and 28 could be rigidly attached to side brackets 24, and the link members 34 and 36 could be attached to the upper frame assembly 20 with a pivot joint.

Referring to FIGS. 3 and 4, a lifting mechanism, indicated generally at 60 is shown. Lifting mechanism 60 may be used to adjust the vertical height of the vehicle seat frame 10 relative to the floor. It should be understood that the lifting mechanism 60 shown and described is only one example of a suitable lifting mechanism and any type of mechanism capable of moving the upper frame assembly 20 relative to the lower frame assembly 22 may be used. The lifting mechanism 60 can be a single unit mounted on only one side of the vehicle seat frame 10 or may include two separate components one for each side of the vehicle seat frame 10. The illustrated lifting mechanism 60 includes a drive unit 62, a cylinder 63 (shown in cross-section in FIGS. 3 and 4), and a threaded rod 64. A first end 66 of the cylinder 63 is pivotally connected to an extension portion 67 of one of the rear link members 36. A second end 69 of the cylinder 63 is threadably engaged with a first end 68 of the threaded rod 64. A second end 70 of the threaded rod 64 is engaged with the drive unit 62 for rotational movement when the drive unit 62 is actuated. The drive unit 62 can include an electric motor which is operatively connected to the second end 70 of the threaded rod 64 for selectively rotating the threaded rod 64. The drive unit 62 is pivotally connected to an extension portion 74 of one of the front link members 34.

The operation of the lifting mechanism 60 for adjusting the vertical height of the seat bottom frame 14 (and the attached seat back frame 12) relative to the floor will now be described. In FIG. 3, the seat bottom frame 14 is shown in a lowered position. To move the seat bottom frame 14 generally upwardly, the motor of the drive unit 62 is actuated to rotate the threaded rod 64 in a desired rotational direction. The rotation of the threaded rod 64 in threaded engagement with the cylinder 63 causes the lifting mechanism 60 to expand in length such that the threaded rod 64 extends outwardly from the cylinder 63, as shown in FIG. 4. The expansion of the lifting mechanism 60 causes the front and rear link members 34 and 36 to pivot about their pivoting connection with the lower frame assembly 22 in a counter-clockwise direction, as viewing FIGS. 3 and 4. The pivoting motion of the link members 34 and 36 causes the upper frame assembly 20 to move upwardly and forwardly (leftward), as viewing FIGS. 3 and 4. The link members 34 and 36, the upper frame member 20 and the lower frame member 22 generally function as a unit of four bar linkages.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A vehicle seat having a mounting frame assembly connected to the vehicle floor, a seat bottom frame mounted for movement relative to the mounting frame assembly, and a link member connecting the mounting frame assembly and the seat bottom frame, the link member having a first connection to the seat bottom frame at one end of the link member and a second connection to the mounting frame assembly at another end of the link member, wherein one of the first connection and the second connection allows pivotal movement and includes a protruding member extending through an aperture, and wherein the protruding member is retained within the aperture;
characterized in that the protruding member is a part of one of the mounting frame assembly, the seat bottom frame and the link member.

2. The vehicle seat of claim 1, wherein the protruding member is tubular.

3. The vehicle seat of claim 2, wherein the protruding member is part of the link member.

4. The vehicle seat of claim 3, wherein the protruding member is integral with the link member.

5. The vehicle seat of claim 4, wherein the aperture is defined by the mounting frame assembly.

6. The vehicle seat of claim 5, wherein the protruding member is rolled over the mounting frame assembly.

7. The vehicle seat of claim 6, wherein a bushing is disposed between the protruding member and the mounting frame assembly.

8. The vehicle seat of claim 4, wherein the protruding member is retained within the aperture by a pin.

9. The vehicle seat of claim 3, wherein the protruding member is welded to the link member.

10. The vehicle seat of claim 2, wherein the protruding member is part of the mounting frame assembly.

11. The vehicle seat of claim 2, wherein the protruding member is part of the seat bottom frame.

12. The vehicle seat of claim 2, wherein a bushing is disposed within the aperture adjacent the protruding member.

13. The vehicle seat of claim 1, wherein the other of the first connection and the second connection allows pivotal movement.

14. The vehicle seat of claim 1, wherein the other of the first connection and the second connection is fixedly attached.
